(19) United States
(12) Patent Application Publication
(10) Pub. No.: US 2025/0302591 A1
(43) Pub. Date: Oct. 2, 2025

(54) ORTHODONTIC SYSTEMS AND METHODS OF USING SAME

(71) Applicant: Smilenext, Inc., Markham (CA)

(72) Inventors: Colin James Corey, Carlsbad, CA (US); Samuel Joseph Ettinger, South Pasadena, CA (US); James E. Paschal, JR., Madison, GA (US)

(21) Appl. No.: 18/769,954

(22) Filed: Jul. 11, 2024

Related U.S. Application Data
(60) Provisional application No. 63/572,660, filed on Apr. 1, 2024.
(60) Provisional application No. 63/635,097, filed on Apr. 17, 2024.

(51) Int. Cl. A61C 7/14; B33Y 50/02; B33Y 80/00

(52) U.S. Cl. CPC A61C 7/146; B33Y 50/02; B33Y 80/00

(57) ABSTRACT

In some embodiments, apparatuses and methods are provided herein useful to orthodontic systems. In some embodiments, an orthodontic system comprises a registration assembly comprising a first main body, at least one registration feature configured to contact a feature in a patient's mouth to align the orthodontic system in the patient's mouth, and a first mating element including at least one post extending from the first main body, and an appliance assembly comprising a second main body, a plurality of support structures extending from the second main body, a plurality of orthodontic appliances secured to the second main body via the plurality of support structures, and at least one aperture extending into the second main body, wherein the at least one aperture is configured to mate with the first mating element.

### TECHNICAL FIELD

This invention relates generally to orthodontics and, more specifically, orthodontic systems.

### BACKGROUND

Orthodontic clinicians seek to correct malocclusions by use of many different devices, such as braces, retainers, pallet expanders, positioners, etc. Braces, one of the most commonly used devices, include a number of orthodontic appliances such as brackets and archwires. The brackets are affixed to a patient's teeth and the archwire passes through slots in the brackets designed to receive the archwire. Traditionally, orthodontic appliances were directly bonded to the patient's teeth. That is, an orthodontic clinician would individually place and adhere each orthodontic appliance to each tooth. Alternatively, orthodontic appliances can be indirectly bonded to the patient's teeth. Indirect bonding typically utilizes a bonding tray into which the orthodontic appliances are placed. The orthodontic clinician then places the bonding tray, including the orthodontic appliances, into the patient's mouth and bonds multiple appliances simultaneously.

While indirect bonding can be faster than direct bonding, it includes a number of drawbacks. One such drawback is that, as orthodontic appliances are quite small, they can be difficult to place, and properly orient, in a bonding tray. Additionally, because the bonding material (e.g., and adhesive) is applied to the appliances before placement of the bonding tray in the patient's mouth, when appliances are indirectly bonded, the result is often excess bonding material being deposited on the patient's teeth. Accordingly, a need exists for systems, methods, and apparatuses that overcome these drawbacks.

### BRIEF DESCRIPTION OF THE DRAWINGS

Disclosed herein are embodiments of systems, apparatuses, and methods pertaining to orthodontic systems. This description includes drawings, wherein:

FIG. 1A is a first perspective view of an appliance assembly of a first embodiment of an orthodontic system, according to some embodiments;

FIG. 1B is a second perspective view of an appliance assembly of a first embodiment of an orthodontic system, according to some embodiments;

FIG. 1C is a third perspective view of an appliance assembly of a first embodiment of an orthodontic system, according to some embodiments;

FIG. 2A is a top view of a registration assembly of a first embodiment of an orthodontic system, according to some embodiments;

FIG. 2B is a perspective view of a registration assembly of a first embodiment of an orthodontic system, according to some embodiments;

FIG. 3A is a side view of a registration assembly of a first embodiment of an orthodontic system, according to some embodiments;

FIG. 3B is an enlarged view of a portion of a registration assembly of a first embodiment of an orthodontic system, according to some embodiments;

FIG. 4A is a first detail view of an appliance assembly and a registration assembly of a first embodiment of an orthodontic system, according to some embodiments;

FIG. 4B is a second detail view of an appliance assembly and a registration assembly of a first embodiment of an orthodontic system, according to some embodiments;

FIG. 5 is a third detail view of an appliance assembly and a registration assembly of a first embodiment of an orthodontic system, according to some embodiments;

FIG. 6 is a third detail view of an appliance assembly and a registration assembly of a first embodiment of an orthodontic system, according to some embodiments;

FIG. 7A is a front view of a registration assembly of a second embodiment of an orthodontic system, according to some embodiments;

FIG. 7B is a perspective view of a registration assembly of a second embodiment of an orthodontic system, according to some embodiments;

FIG. 8 is a perspective view of an appliance assembly of a second embodiment of an orthodontic system, according to some embodiments;

FIG. 9 is a perspective view of an appliance assembly of a second embodiment of an orthodontic system, according to some embodiments;

FIG. 10 is a detail view of a registration assembly and an appliance assembly of a second embodiment of an orthodontic system, according to some embodiments;

FIG. 11 is a perspective view of an appliance assembly of a third embodiment of an orthodontic system, according to some embodiments;

FIG. 12 is a perspective view of an appliance assembly, including orthodontic appliances, of a third embodiment of an orthodontic system, according to some embodiments;

FIG. 13A is detail view of an orthodontic appliance receptacle of an appliance assembly of a third embodiment of an orthodontic system, according to some embodiments;

FIG. 13B is a perspective view of an orthodontic appliance receptacle of an appliance assembly of a third embodiment of an orthodontic system, according to some embodiments;

FIG. 14A is a cross-sectional view of an orthodontic appliance receptacle of an appliance assembly of a third embodiment of an orthodontic system, according to some embodiments;

FIG. 14B is a cross-sectional view of an orthodontic appliance receptacle of an appliance assembly of a third embodiment of an orthodontic system in which an orthodontic appliance is retained, according to some embodiments;

FIG. 15 is a perspective view of a registration assembly and an appliance assembly of a third embodiment of an orthodontic system, according to some embodiments;

FIG. 16 is a perspective view of a registration assembly and an appliance assembly, including orthodontic appliances, of a third embodiment of an orthodontic system, according to some embodiments;

FIG. 17 is a perspective view of a registration assembly and an appliance assembly, including orthodontic appliances, of a third embodiment of an orthodontic system, according to some embodiments;

FIG. 18A is a perspective view of a registration assembly of the second and/or third embodiment of an orthodontic system, according to some embodiments;

FIG. 18B is a cross-sectional view of a registration assembly of the second and/or third embodiment of an orthodontic system, according to some embodiments;

FIG. 19A is a top view of registration features of a registration assembly of the second and/or third embodiment of an orthodontic system, according to some embodiments;

FIG. 19B is a side view of registration features of a registration assembly of the second and/or third embodiment of an orthodontic system, according to some embodiments;

FIG. 19C is a top view of registration features and connectors of a registration assembly of the second and/or third embodiment of an orthodontic system, according to some embodiments;

FIG. 19D is a side view of registration features and connectors of a registration assembly of the second and/or third embodiment of an orthodontic system, according to some embodiments;

FIG. 19E is a top view of a registration assembly of the second and/or third embodiment of an orthodontic system, according to some embodiments;

FIG. 19F is a side view of a registration assembly of the second and/or third embodiment of an orthodontic system, according to some embodiments;

FIG. 20 is a block diagram of a system for additively manufacturing an orthodontic system, according to some embodiments; and

FIG. 21 is a flow diagram depicting example operations for additively manufacturing an orthodontic system, according to some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure.

### DETAILED DESCRIPTION

Generally speaking, pursuant to various embodiments, systems, apparatuses, and methods are provided herein useful to orthodontic systems. In some embodiments, an orthodontic system comprises a registration assembly, wherein the registration assembly comprises a first main body, at least one registration feature, wherein the at least one registration feature is configured to contact a feature in a patient's mouth to align the orthodontic system in the patient's mouth, and a first mating element, wherein the first mating element includes at least one post extending from the first main body, and an appliance assembly, wherein the appliance assembly comprises a second main body, a plurality of support structures, wherein the plurality of support structures extend from the second main body, a plurality of orthodontic appliances, wherein the plurality of orthodontic appliances are secured to the second main body via the plurality of support structures, and at least one aperture, wherein the at least one aperture is extends into the second main body, and wherein the at least one aperture is configured to mate with the first mating element.

As previously discussed, in certain cases and for some patients, indirect bonding can be a convenient way to place orthodontic appliances in a patient's mouth. For example, it is often faster and more efficient to bond multiple orthodontic appliances at the same time. However, there are drawbacks to indirect bonding. One such drawback is that, as orthodontic appliances are quite small, they can be difficult to place, and properly orient, in a bonding tray. Additionally, because as the bonding material (e.g., and adhesive) is applied to the appliances before placement of the bonding tray in the patient's mouth when appliances are indirectly bonded, the result is often excess bonding material being deposited on the patient's teeth. Accordingly, a need exists for systems, methods, and apparatuses that overcome these drawbacks.

Described herein are systems, methods, and apparatuses that seek to minimize, if not eliminate, these and other issues. In one embodiment, an orthodontic system comprises a registration assembly and an appliance assembly. The registration assembly includes a first main body, one or more registration features, and a first mating element. The one or more registration features and the first mating element are located on the first main body. The registration features are configured to contact a feature in the patient's mouth. For example, the registration features can contact teeth (e.g., a facial, lingual, and/or occlusal surface of teeth) in the patient's mouth. The one or more registration features can be located on one side, or multiple sides, of the registration assembly. In some embodiments, the one or more registration features are designed with a geometry that matches a geometry of the features in the patient's mouth that the registration features contact. The appliance assembly comprises a second main body, a plurality of support structures, a plurality of orthodontic appliances (or orthodontic appliance receptacles), and a second mating element. The second mating element is configured to mate with the first mating element. When the second mating element and the first mating element mate, the orthodontic appliances are aligned with respect to the registration assembly and thus the patient's teeth. The orthodontic appliances can then be secured (e.g., adhered) to the patient's teeth. The following discussion describes various embodiments of such an orthodontic system.

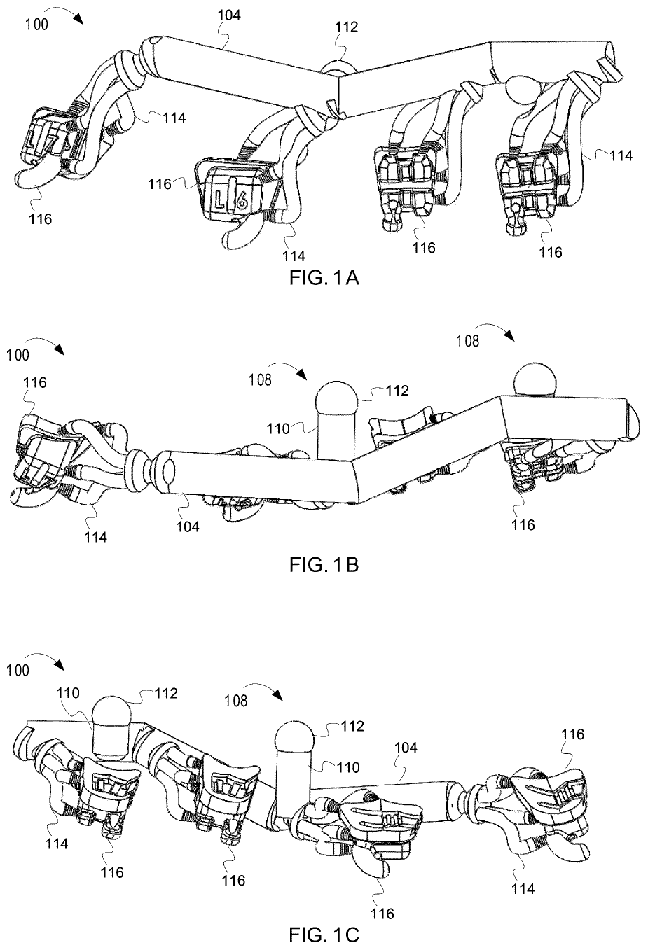

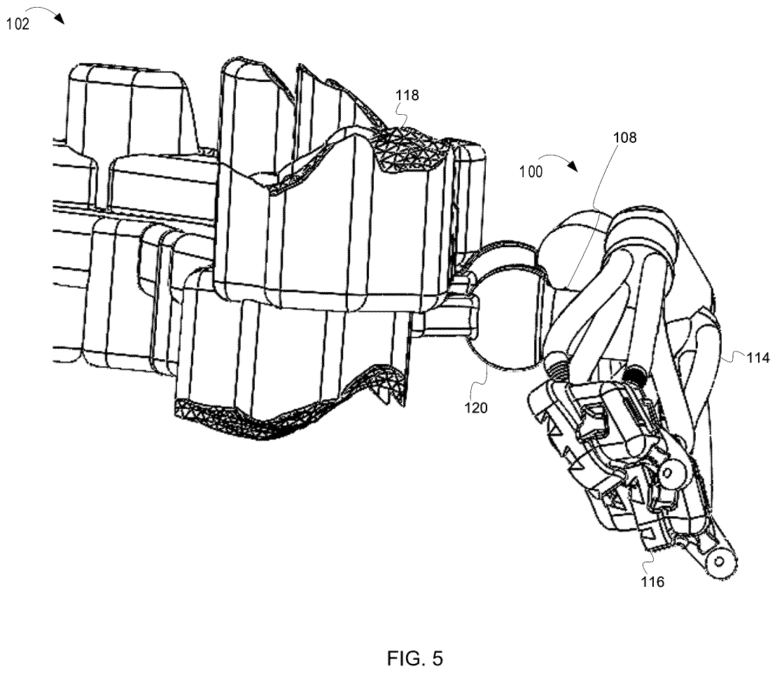

FIGS. 1-6 depict various components of a first embodiment of an orthodontic system, according to some embodiments. Specifically, FIGS. 1A-1C depict various views of an appliance assembly 100 of the first embodiment of the orthodontic system. The appliance assembly 100 generally comprises a second main body 104, a plurality of support structures 114, a plurality of orthodontic appliances 116, and at least one second mating element 108.

The plurality of support structures 114 extend from the second main body 104, and the orthodontic appliances 116 are secured to the second main body 114 via the plurality of support structures 114. The orthodontic appliances 116 are configured to be severed or otherwise disconnected from the appliance assembly 100 once the orthodontic appliances 116 have been secured to the patient's teeth. For example, after securing the orthodontic appliances 116 to the patient's teeth, the clinician can break, cut, etc. the plurality of support structures 114 such that the appliances assembly 100, without the orthodontic appliances 116, can be removed from the patient's mouth. In one embodiment, the plurality of support structures 114 includes joints where the support structures 114 meet the orthodontic appliances 116. The joint can be designed to break, fracture, etc. at a specific point such that the orthodontic appliances 116 can be cleanly removed from the support structures 114. For example, the joint can be an area of weakened material, thinner material, brittle material, etc.

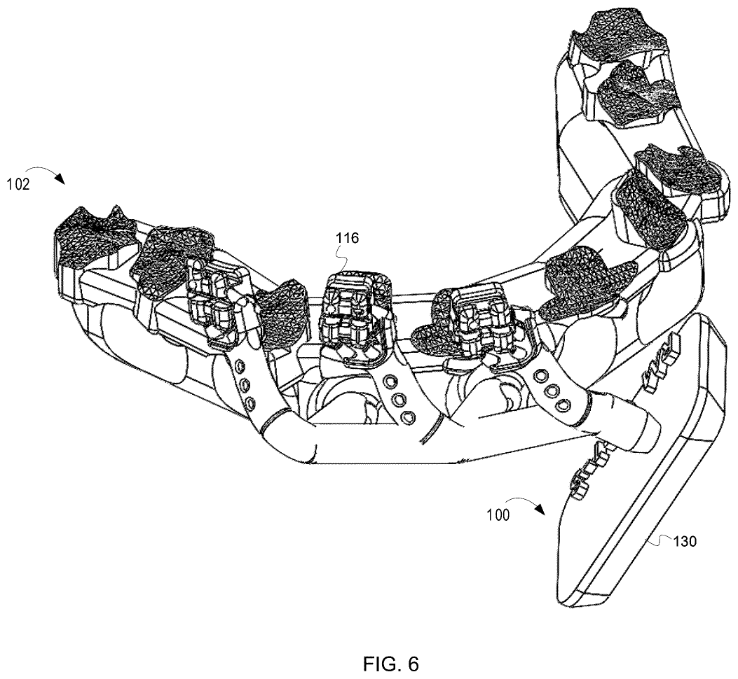

The support structures 114, the geometry of the appliance assembly 100, and/or the geometry of the second main body 102 provides the orthodontic appliances 116 with orientations. In one embodiment, the orientations of the orthodontic appliances 116 are based on the patient's dentition (e.g., an intraoral scan, X-ray, etc.) such that the orthodontic appliances 116 are properly aligned/oriented for the patient's teeth when the appliance assembly 100 mates with the registration assembly 102 in the patient's mouth. For example, as depicted in FIG. 6, the orthodontic appliance 116 is aligned/oriented relative to the registration assembly 102 (and thus the patient's teeth) based on the geometry of the support structures 114, the geometry of the appliance assembly 100, and/or the geometry of the second main body 102. Further, in some embodiments, the support structures 114 and/or portions of the appliance assembly 100 can include apertures extending therethrough. Such apertures may aid in the additive manufacturing process to prevent cupping.

In some embodiments, the appliance assembly 100 is additively manufactured as a single (i.e., monolithic) structure. In such embodiments, the appliance assembly 100 can be additively manufactured on and/or with a base 130 (as shown in FIG. 6). In the embodiment depicted in FIGS. 1A-1C, the second mating element 108 is a protrusion that includes a post 110 and a second end 112. The second end 112 has a semispherical shape, though such is not required (i.e., the second end 112 can take any suitable form, such as polygonal prism, rounded shape, etc.).

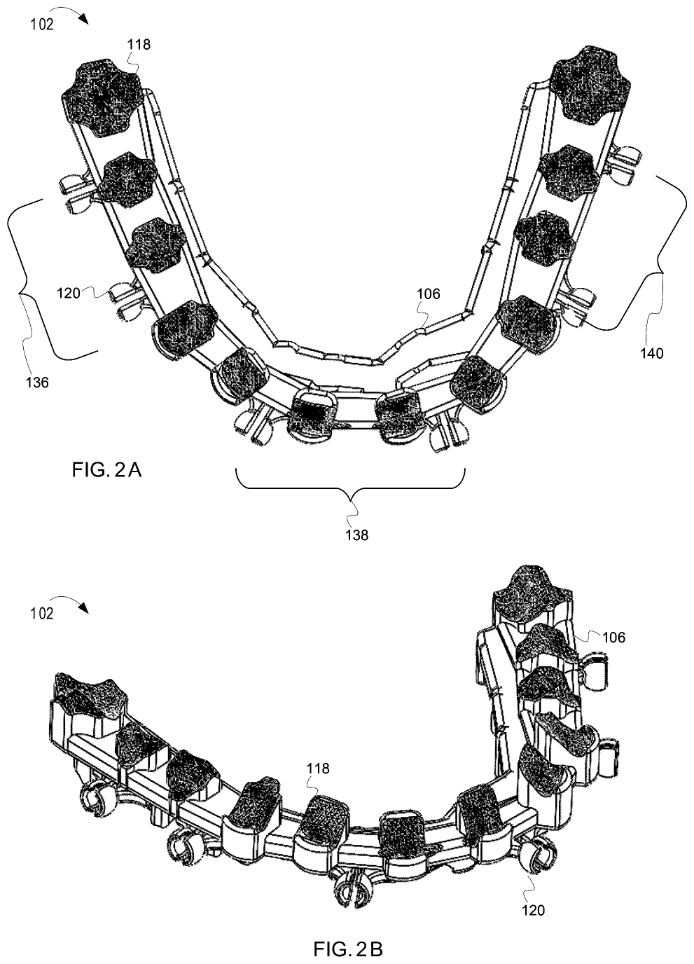

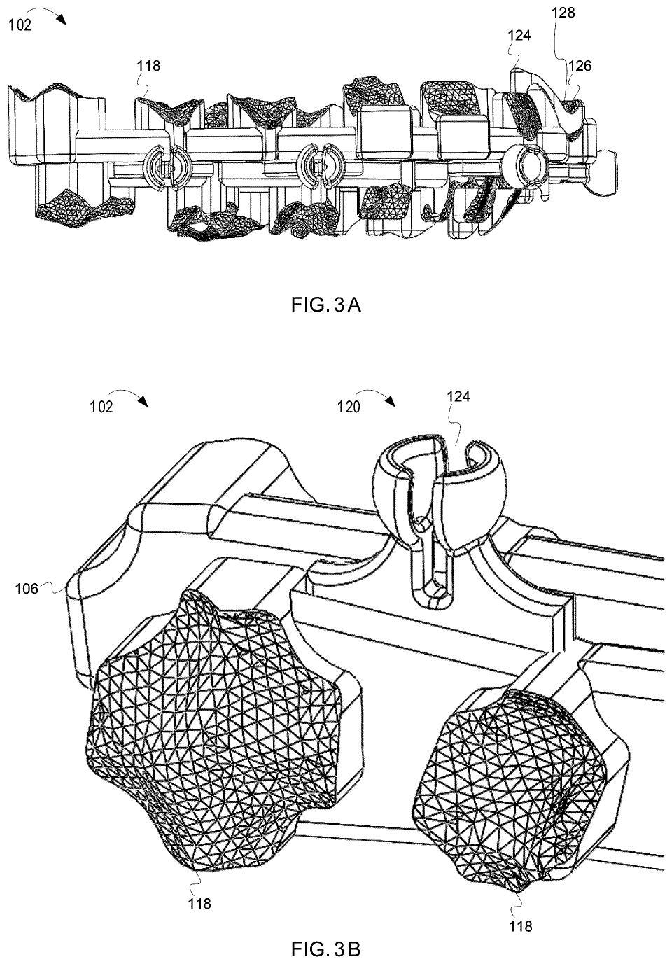

FIGS. 2A-2B and 3A-3B depict various views of a registration assembly 102 of the first embodiment of the orthodontic system. The registration assembly 102 generally comprises a first main body 106, at least one registration feature 118, and a first mating element 120. In some embodiments, the registration assembly 102 is additively manufactured as a single (i.e., monolithic) structure. The registration assembly 102 can be made of the same material as, or a different material than, the appliance assembly 100. For example, the appliance assembly 100, or the registration assembly 102, can be made from a material that is more rigid than that of the other. For example, traditionally, indirect bonding trays were made from a relatively flexible material. Such flexibility was required to allow not only the indirect bonding tray to be placed over the patient's teeth, but also the orthodontic appliances to be placed in, and retained by, the indirect bonding tray. However, the more flexible the material, the less precise the indirect bonding tray is in locating orthodontic appliances on the patient's teeth. With the two-piece design (i.e., the appliance assembly 100 and the registration assembly 102 being separate pieces), a user can select materials specifically for each of the appliance assembly 100 and the registration assembly 102. Accordingly, flexible, semiflexible, semirigid, and/or rigid materials can be selected for each of the appliance assembly 100 and the registration assembly 102. Further, it should be noted that such material selections can be made for all orthodontic systems disclosed herein.

The registration features 118 are configured to contact a feature in the patient's mouth. For example, the registration features 118 can contact facial surfaces, occlusal surfaces, and/or lingual surfaces of teeth in the patient's mouth. The registration features 118 aid in aligning the registration assembly 102 in the patient's mouth. For example, the registration features can be formed based on the geometry of teeth in the patient's mouth. In such embodiments, surfaces (e.g., top, sides, etc.) of the registration features 118 correspond to surface so the patient's teeth such that the registration features 118 seat on the patient's teeth. Additionally, in some embodiments, the registration features 118 aid in retaining the registration assembly 102 in the patient's mouth. In one embodiment, the registration features 118 can contact and/or capture lingual, occlusal, and/or facial surfaces of the patient's teeth. For example, as best seen in FIG. 3A, at least some of the registration features 118 include a lingual portion 124, a facial portion 126, and an occlusal portion 128. The lingual portion 124 is configured to contact a lingual surface of a tooth in the patient's mouth. The facial portion 126 is configured to contact a facial surface of a tooth in the patient's mouth. The occlusal portion 128 is configured to contact an occlusal surface of a tooth in the patient's mouth. As depicted in the example provided in FIG. 3A, the lingual portion 124 extends a greater distance from the occlusal portion 128 than the facial portion 126. In such embodiments, the lingual portion 124 extends around a feature of a tooth, such as a wider/larger portion of a bicuspid. The lingual portion 124 grips the lingual surface of the patient's tooth to aid in retaining the registration assembly 102 in the patient's mouth. Further, in some embodiments, the first main body 106, or portions of the first main body 106, can be wider than the distance between opposite lingual surfaces of the patient's teeth. In such embodiments, the second main body 106 can exert an outward force on the patient's teeth, thus aiding in securing the registration assembly 102 in the patient's mouth. The registration features 118 may be present on one, or two, sides of the registration assembly 102. For example, as depicted in FIG. 3A, the registration assembly 102 includes registration features 118 that mate with occlusal surfaces of teeth in both patient's upper and lower jaws.

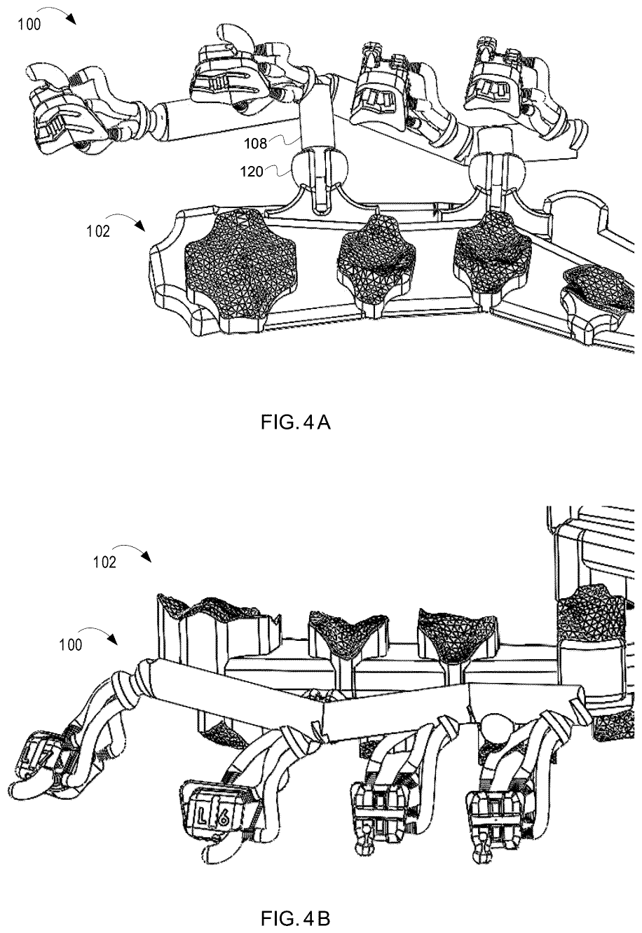

In the embodiment depicted in FIGS. 2-6, the first mating element 120 is an aperture. The first mating element 120 is configured to receive the second mating element 108 of the appliance assembly 100. In the embodiment depicted in FIGS. 1-6, the first mating element 120 is semispherically shaped and the second mating element 108 includes a second end 112 that is semispherically shaped. In use, a clinician can seat the second mating element 108 in the first mating element 120 to secure the appliance assembly 100 to the registration assembly 102, as depicted in FIGS. 4-6. In one embodiment, the second mating element 120 is divided by a gap 124. The gap 124 allows portions of the first mating element 120 to move relative to one another, thus expanding the aperture. Such a gap 124 may make it easier to seat the second mating element 108 in the first mating element 120 and/or remove the appliance assembly 100 from the registration assembly 102.

As depicted in FIG. 2A, the registration assembly 102 includes six first mating elements 120. The first mating elements 120 are divided into groups: 1) a first group 136; 2) a second group 138; and 3) a third group 140. Each group includes two first mating elements 120. Similarly, as best seen in FIG. 1C, the appliance assembly 100 includes two second mating elements 108. Each of the second mating elements 108 is configured to mate with one of the first mating elements 120. Specifically, the two second mating elements 108 of the appliance assembly 100 are configured to mate with two first mating elements 120 of one of the groups of first mating elements 120. It should be noted that such an arrangement can be utilized in any of the embodiments described herein.

In some embodiments, the orthodontic appliances 116 for a portion of the teeth in a patient's mouth are secured at the same time, or nearly at the same time. While the example depicted in FIGS. 1-6 includes four orthodontic appliances 116 on the appliance assembly 100, such is not required. That is, each appliance assembly 100 may include greater or fewer than four orthodontic appliances 116, and each appliance assembly 100 for a patient may not have the same number of orthodontic appliances 116. Further, in some embodiments, the orthodontic appliance assembly 100 may not include orthodontic appliances for each tooth in the patient's mouth. For example, based on the patient's dental geometry and/or malocclusions, it may be beneficial to “skip” one or more teeth. Further, it should be noted that the appliance assembly 100 can include as few as one orthodontic appliance 116. As noted above with respect to FIG. 3A, the registration assembly 102 can include mating features 118 that mate with both the occlusal surfaces of teeth in the patient's upper jaw and occlusal surfaces of teeth in the patient's lower jaw. In such embodiments, the appliance assembly 100 can also include orthodontic appliances for teeth in both the patient's upper and lower jaws, though such is not required.

Further, in some embodiments, the first mating elements 120 and/or the second mating elements 108 can be uniquely shaped to aid in properly mating the appliance assembly 100 with the registration assembly 102 and/or preventing incorrect mating of the appliance assembly 100 with the registration assembly 102. For example, in some embodiments, one or more of the first mating elements 120 and/or the second mating elements 108 can have geometries such that the appliance assembly 100 can only mate with the registration assembly in a single way. For example, a first of the first mating elements 120 and a first of the second mating elements 108 can be rectangular, a second of the first mating elements 120 and a second of the second mating elements 108 can be triangular, and a third of the first mating elements 120 and a third of the second mating elements 108 can be circular. As an example of differing sizes, a first of the first mating elements 120 and a first of the second mating elements 108 can be a first size, and a second of the first mating elements 120 and a second of the second mating elements 108 can be a second, different size. Additionally, or alternatively, the appliance assembly 100 and/or the registration assembly 102 can have markings, coding (e.g., color-coding, word-coding, etc.), etc. that indicates the proper mating of the appliance assembly 100 with the registration assembly 102. Such features can be present in any of the embodiments disclosed herein.

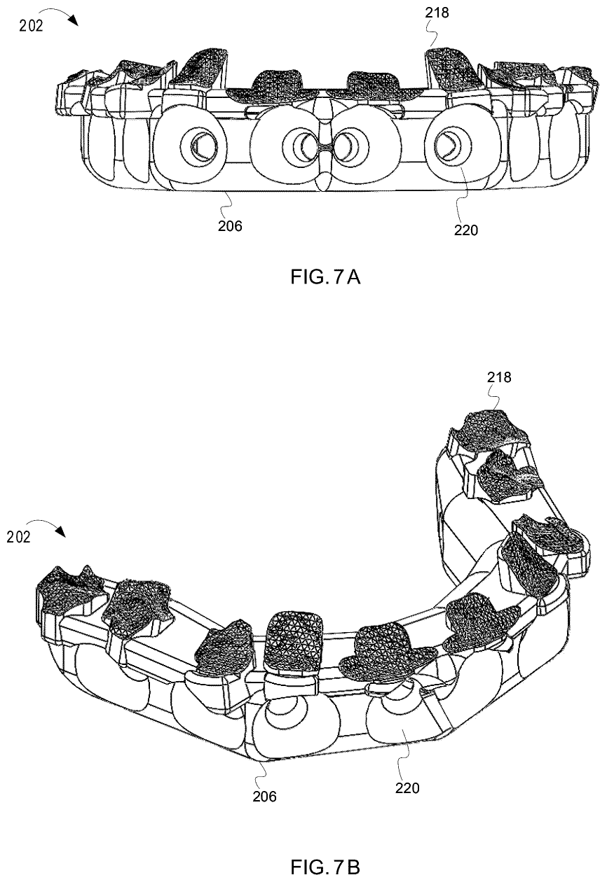

While the discussion of FIGS. 1-6 provides additional detail regarding a first embodiment of an orthodontic system in which the second mating elements include semispherical second ends and the first mating elements include semispherical apertures, the discussion of FIGS. 7-10 provides additional detail regarding a second embodiment of an orthodontic system in which the second mating elements are generally conically shaped.

FIGS. 7-10 depict various components of a second embodiment of an orthodontic system, according to some embodiments.

FIGS. 7A-7B depict a second embodiment of a registration assembly 202, according to some embodiments. The registration assembly 202 generally comprises a first main body 206, at least one registration feature 218, and at least one first mating element 220. Though the registration assembly 202 depicted in and described with respect to FIGS. 7-10 is largely similar to the registration assembly 102 depicted in and described with respect to FIGS. 1-6, the registration assembly 202 differs from the registration assembly 102 in that the first mating element 220 of the registration assembly 202 includes conically shaped apertures. For example, as depicted in FIGS. 7A and 7B, the first mating elements 220 include conically shaped openings. The conically shaped openings extend to cylindrical openings, as depicted in FIGS. 7A and 7B.

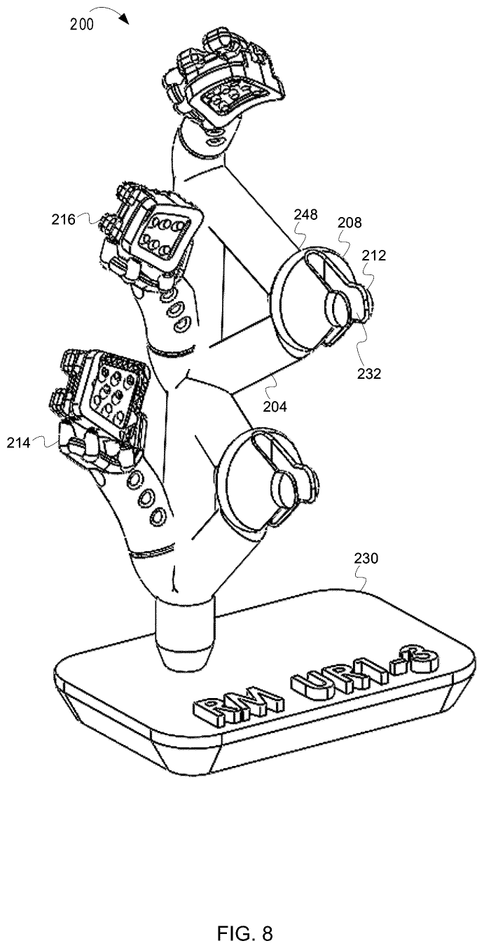

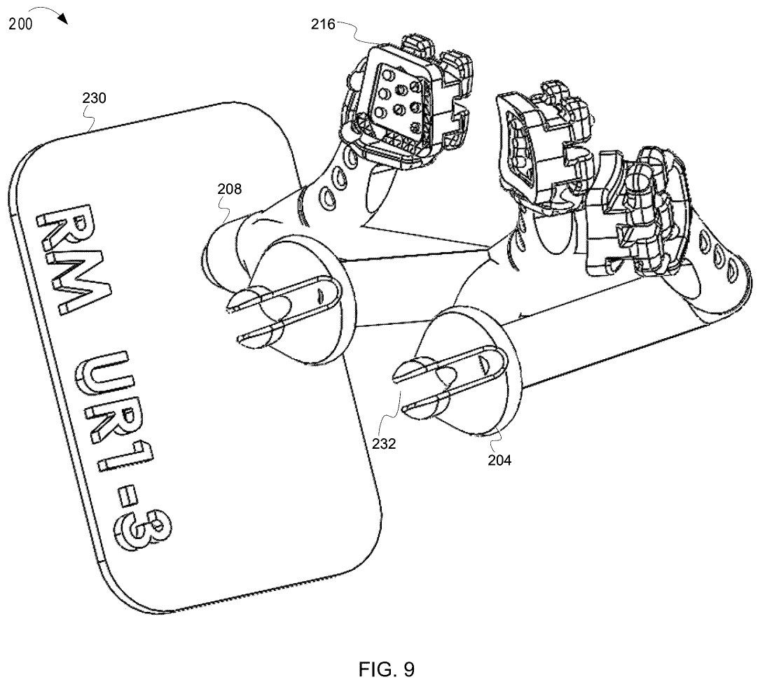

FIGS. 8-9 depict a second embodiment of an appliance assembly 200, according to some embodiments. The appliance assembly 200 generally comprises a second main body 204, a plurality of support structures 214, and orthodontic appliances 216. The appliance assembly 200 can be additively manufactured on a base 230, as shown in FIG. 8. Though the appliance assembly 200 depicted in and described with respect to FIGS. 7-10 is largely similar to the appliance assembly 100 depicted in and described with respect to FIGS. 1-6, the appliance assembly 200 differs from the appliance assembly 100 in that the second mating element 208 of the appliance assembly 202 includes conically shaped protrusions. A second end 212 of the second mating element 208 is generally cylindrically shaped.

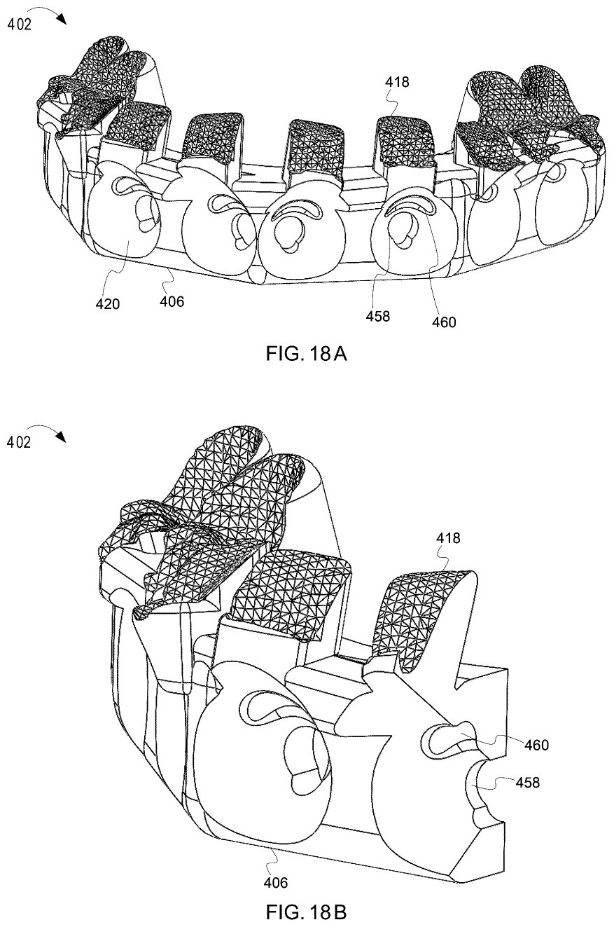

As with the registration assembly 102 and appliance assembly 100 of FIGS. 1-6, the first mating elements 220 of the registration assembly 202 mate with the second mating elements 208 of the appliance assembly 200. The complimentary conical shapes of the first mating elements 220 and the second mating elements 208 aid in locating the appliance assembly 200 with respect to the registration assembly 202 by guiding the second mating elements 208 into the first mating elements 220. Further, in some embodiments, the first mating elements 220 and/or the second mating elements 208 can aid in retaining the appliance assembly 200 with respect to the registration assembly 202. For example, as noted previously, the first mating elements 208 include a cylindrical portion of the aperture and the second mating elements 208 include a second end 212 that is generally cylindrically shaped. In some embodiments, the cylindrical portion of the first mating elements 220 can have a smaller diameter than that of the second ends 212 of the second mating elements 208. Accordingly, the interaction between the cylindrical portion of the first mating elements 220 and the second ends 212 of the second mating elements 208 can aid in retaining the appliance assembly 200 with respect to the registration assembly 202. Further, as depicted in FIG. 8, the second end 212 of the second mating element 208 can be split by a gap 232. The gap 232 can allow the second end 212 of the second mating element 208 to deform when mating with the first mating element 220. The second end 212 of the second mating element 208 can include a resilient material that applies an elastic force on an inner surface of the first mating element 220. Additionally, in some embodiments, the second end 212 of the second mating element 208 can be rounded to aid in locating the second mating element 208 with the first mating element 220. Mating between the first mating elements 220 and the second mating elements 208 is described in more detail with respect to FIGS. 18A and 18B.

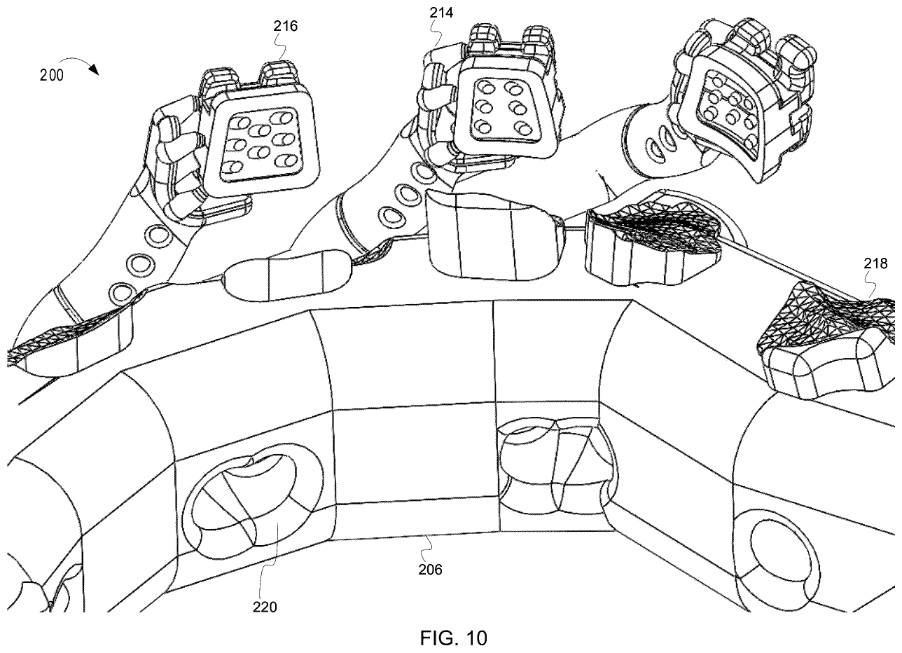

As depicted in FIG. 10, the orthodontic system is assembled by mating the appliance assembly 200 with the registration assembly 202 via the first mating elements 220 and the second mating elements 208.

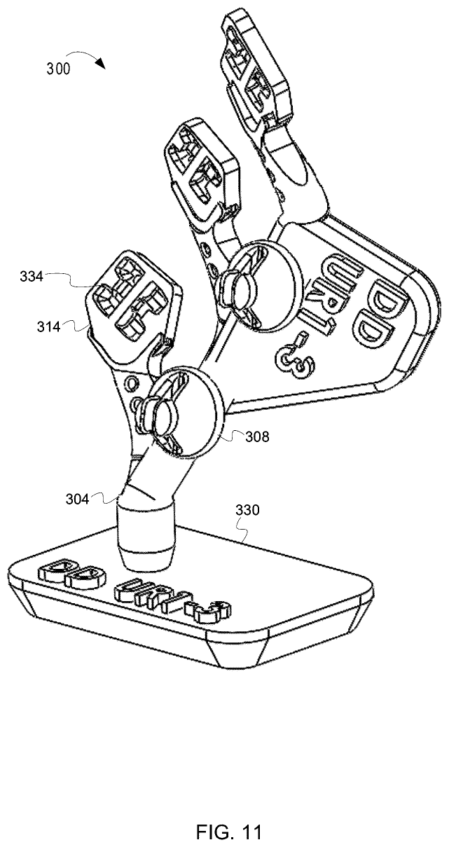

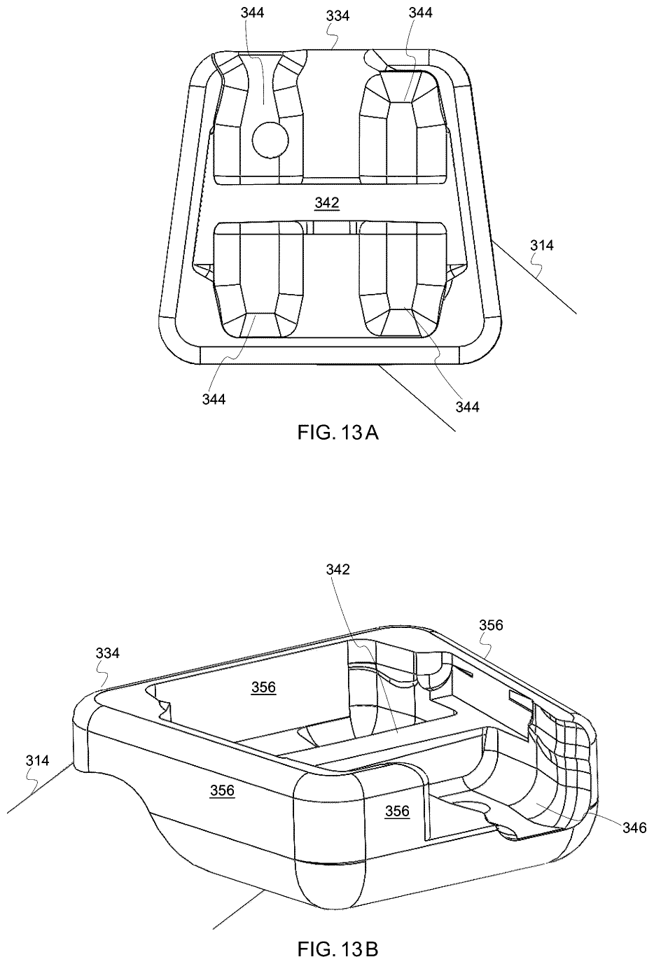

While the discussion of FIGS. 7-10 provides additional detail regarding a second embodiment of an orthodontic system in which the second mating elements are generally conically shaped, the discussion of FIGS. 11-17 describes a third embodiment of an orthodontic system in which the appliance assembly includes orthodontic appliance receptacles.

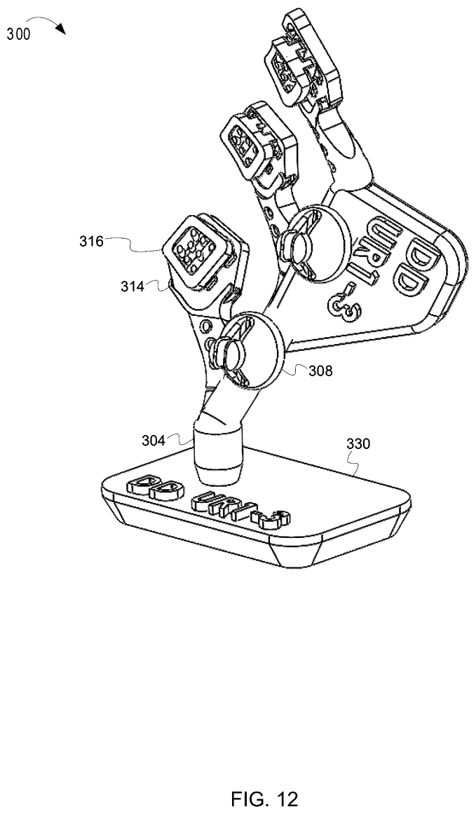

FIGS. 11-17 depict various components of a third embodiment of an orthodontic system, according to some embodiments. FIGS. 11-12 depict a third embodiment of an appliance assembly 300, according to some embodiments. The appliance assembly 300 as depicted in FIGS. 11-12 is generally similar to the appliance assembly 100 depicted and described with respect to FIGS. 1-6 and the appliance assembly 200 depicted and described with respect to FIGS. 7-10. However, while the appliance assembly 100 and the appliance assembly 200 include orthodontic appliances 116, 216, the appliance assembly 300 does not include orthodontic appliances 316. Rather, the appliance assembly 300 generally comprises a second main body 304, a plurality of support structures 314, and a plurality of orthodontic appliance receptacles 334. The appliances assembly 300 can be, in some embodiments, additively manufactured on a base 330. The orthodontic appliance receptacles 334 are secured to the second main body 304 via the plurality of support structures 314. The orthodontic appliance receptacles are configured to receive orthodontic appliances 316 (as depicted in FIG. 12) and secure the orthodontic appliances 316 to the appliance assembly 300.

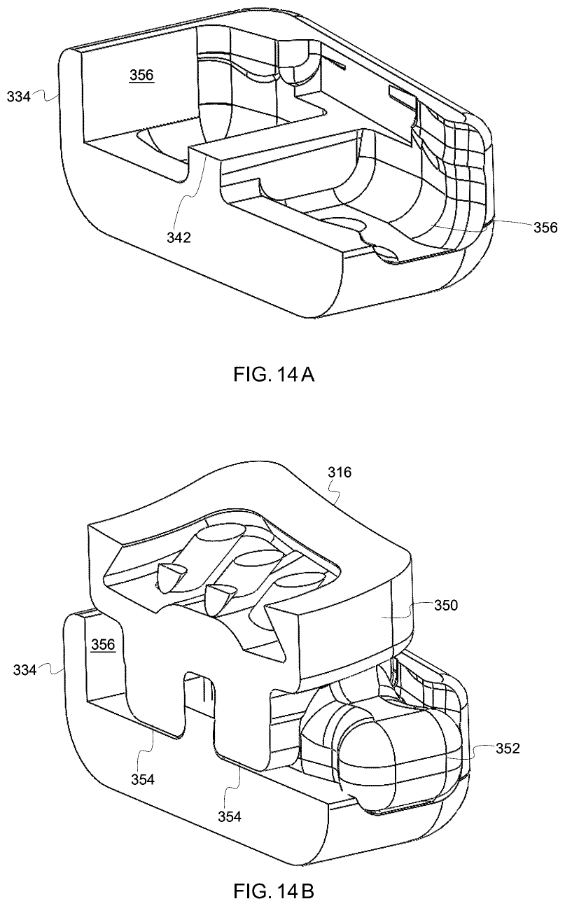

The orthodontic appliance receptacles 334 can take any suitable shape. For example, as depicted in FIGS. 11 and 13-14, the orthodontic appliance receptacles 334 can be shaped to match a surface of one of the orthodontic appliances 316 that is to be secured via the orthodontic appliance receptacle 334. As depicted in FIGS. 11 and 13-14, the orthodontic appliance receptacles 334 is generally a cavity into which an orthodontic appliance 316 can seat, the periphery of which is defined by walls 356. In some embodiments, the orthodontic appliance receptacle 334 includes a number of features to aid in retaining an orthodontic appliance 316 and/or ensuring that the orthodontic appliance 316 is properly oriented with respect to the orthodontic appliance receptacle 334 and/or properly seated within the orthodontic appliance receptacle 334. For example, the orthodontic appliance receptacle 334 includes tiewing receptacles 344. The tiewing receptacles 344 are configured to receive tiewings 354 of the orthodontic appliance 316. Additionally, the orthodontic appliance receptacle 334 includes an archwire slot protrusion 342. The archwire slot protrusion 342 extends from the orthodontic appliance receptacle 334 and is configured to seat in an archwire slot of the orthodontic appliance 316. Additionally, the orthodontic appliance receptacle 334 includes an opening 346. The opening 346 is configured to allow a portion of the orthodontic appliance 316, such as a hook 352, to extend beyond the walls 356 of the orthodontic appliance receptacle 334. It should be noted that, in some embodiments, the walls 356 of the orthodontic appliance receptacle are designed so as to not extend over a base 350 of the orthodontic appliance 334, as best seen in FIG. 14B. In such embodiments, the orthodontic appliance receptacles 334 may provide greater clearance and/or space around the orthodontic appliance 316, allowing greater access to the area to, for example, remove excess bonding material. Further, it should be noted that, in some embodiments, some or all of the orthodontic appliance receptacles 334 may lack these features. For example, the orthodontic appliance receptacles may simply be hollow chambers into which the orthodontic appliances 316 are placed. As another example, the orthodontic appliance receptacles 334 can include retention elements. For example, the retention elements can be protrusion (e.g., fingers) that extend into the orthodontic appliance receptacle 334 that grasp or otherwise secure the orthodontic appliances 316. Additionally, in some embodiments, the retention elements can be biased, for example, by a spring.

As alluded to previously, the geometry of the orthodontic appliance receptacle 334 can be dictated based on the orthodontic appliance 316 to be secured via the orthodontic appliance receptacle 334. That is, one or more of the orthodontic appliance receptacles 334 can be specific to one of the orthodontic appliances 316. Additionally, the desired amount of retention can be controlled based on the geometry of the orthodontic appliance receptacles 334. For example, the orthodontic appliances can be dimensioned to be slightly smaller than the orthodontic appliances 316 to increase retention, the orthodontic appliance receptacles can include clips and/or undercuts to increase retention, etc.

The support structures 314 and/or the geometry of the orthodontic appliance receptacles 334 can provide proper orientations to the orthodontic appliances 316. For example, the support structures 314 can position the orthodontic appliance receptacle 334 such that the orthodontic appliance 316 is in the correct location on the patient's tooth. Additionally, the angle of the support structures 314 can properly orient the orthodontic appliance 316 with respect to the patient's tooth. Additionally, or alternatively, the orthodontic appliance receptacle 334 can be angled, positioned, and/or oriented to properly orient the orthodontic appliance 316 with respect to the patient's tooth. Accordingly, the appliance assembly 300 can be designed and manufactured based on the patient's dentition. For example, the appliance assembly 300 can be designed and manufactured based on a scan of the patient's dentition, final tooth positions for the patient, X-rays of the patient, etc.

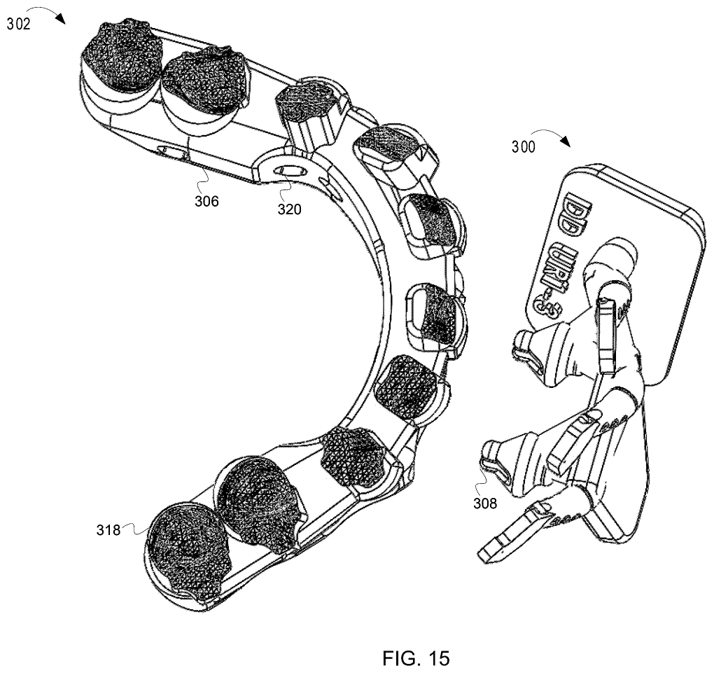

FIGS. 15-17 depict both the appliance assembly 300 and the registration assembly 302. The registration assembly 302 depicted in FIGS. 15-17 is generally similar to the registration assembly 200 depicted in and described with respect to FIGS. 7-10. The registration assembly 302 generally comprises a first main body 306, at least one registration feature 318, and at least one first mating element 320. The second mating elements 308 of the appliance assembly 300 mate with the first mating elements 320 of the registration assembly 302.

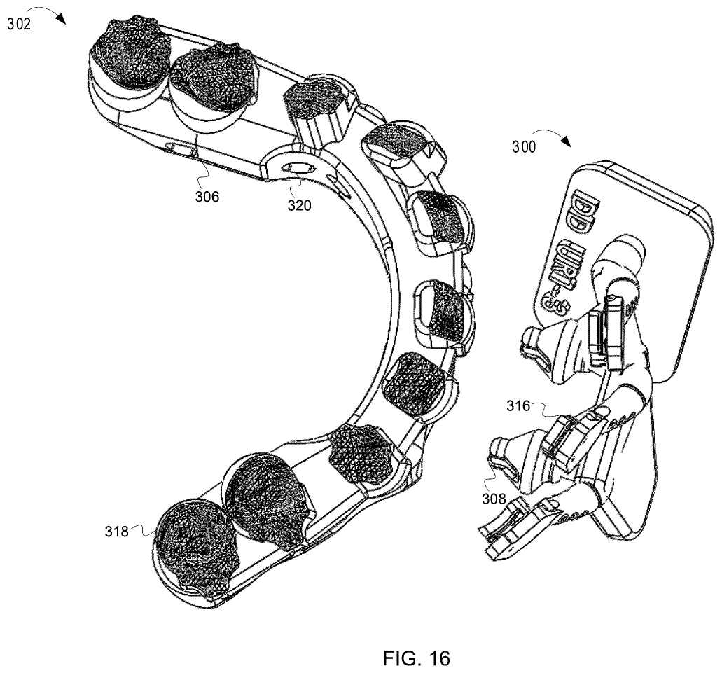

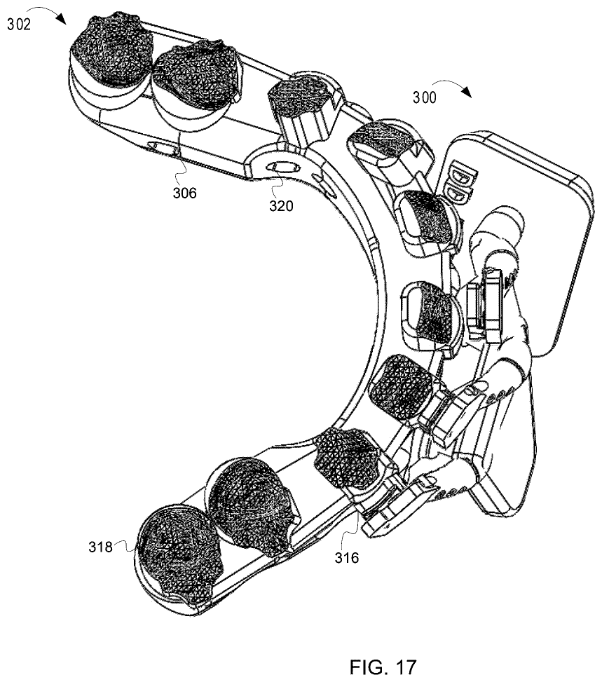

As depicted in FIG. 15, the appliance assembly 300 has not been mated with the registration assembly 302. Additionally, the appliance assembly 300 does not include orthodontic appliances 316. As depicted in FIG. 16, the appliances assembly 300 has not been mated with the registration assembly 302. The appliance assembly 300 includes the orthodontic appliances 316. That is, in FIG. 16, the orthodontic appliances 316 have been secured to the appliance assembly 300 via the orthodontic appliance receptacles 334. As depicted in FIG. 17, the appliance assembly 300 has been mated with the registration assembly 302 via the second mating elements 308 and the first mating elements 320. Once the orthodontic appliances 316 are secured to the patient's teeth, the orthodontic system can be removed from the patient's mouth, leaving only the orthodontic appliances 316. For example, the appliances assembly 300 can be removed from the registration assembly 302 and from the patient's mouth, or the appliance assembly 300 and the registration assembly 302 can both be removed from the patient's mouth together.

While FIGS. 11-17 provide additional detail regarding a third embodiment of an orthodontic system in which the appliance assembly includes appliance receptacles, the discussion of FIG. 18 describes additional features of first mating elements of a registration assembly with respect to the second and third embodiments of an orthodontic system.

FIGS. 18A and 18B are perspective and cross-sectional views, respectively, of a registration assembly 402 according to some embodiments. The registration assembly generally comprises a first main body 406, registration features 418, and a first mating element 420. The first mating element 420 is a generally conical aperture that extends to a generally cylindrical aperture. The first mating element 420 is configured to mate with a second mating element, such as the second mating element 208, 308 depicted in and described with respect to FIGS. 7-17. The second mating element 208, 308 includes a frustoconical portion extending to a cylindrical second end 212, 312.

The first mating element 420 includes a first retention feature 458 and a second registration point 460. In the embodiment depicted in FIGS. 18A and 18B, the second retention feature 460 is the generally cylindrical aperture. That is, when the second mating element 208, 308 begins to mate with the first mating element 420, the cylindrical second end 212, 312 engages with the generally cylindrical aperture (i.e., the first retention feature 458). Dimensionally, the cylindrical second end 212, 312 is larger than the generally cylindrical aperture. Accordingly, the cylindrical second end 212, 312 deforms when it engages the generally cylindrical aperture. Such deformation causes the appliance assembly 200, 300 to be retained by the registration assembly 402 by the first retention feature 458. The appliance assembly 200, 300 and/or the registration assembly 402 can be dimensioned such that the first retention feature 458 retains the appliance assembly 200, 300 at a specified first distance from the registration assembly 402. For example, the appliance assembly 200, 300 and/or the registration assembly 402 can be dimensioned such that when the appliance assembly 200, 300 is retained via the first retention feature 458 the orthodontic appliances 216, 316 do not yet touch the patient's teeth.

The second retention feature 460 is configured to engage the second mating element 208, 308 after the first retention feature 458 engages the second mating element 208, 308. For example, the second retention feature 460 engages the second mating element 208, 308 as the appliance assembly 200, 300 is moved closer to the registration assembly 402. The second retention feature 460 is a recess located in the first mating element 406. In some embodiments, and as depicted in FIGS. 18A and 18B, the second retention feature 460 includes an undercut that engages a first end 248 of the second mating element 208, 308. The appliance assembly 200, 300 and/or the registration assembly 402 can be dimensioned such that the second retention feature 460 retains the appliance assembly 200, 300 at a specified second distance from the registration assembly 402. For example, the appliance assembly 200, 300 and/or the registration assembly 402 can be dimensioned such that the orthodontic appliances 216, 316 contact the patient's teeth when the appliance assembly 200, 300 is retained via the second retention feature 460. Such a design may prevent excess bonding material from being deposited on the patient's teeth, as the orthodontic appliances 316 travel in a generally linear trajectory when the appliance assembly 200, 300 is moved from being retained via the first retention feature 458 and the second retention feature 460. To achieve such spacing, the first retention feature 458 and the second retention feature can be spaced apart from one another by any suitable distance. For example, the first retention feature 458 can be spaced from the second retention feature 460 by between one millimeter and ten millimeters.

It should be noted that, while the example appliance assembly 100, 200, 300 and registration assembly 102, 202, 302, and 402 are shown with a second mating element 108, 208, 308 that extends from the second main body 104, 204, 304 (e.g., a post or protrusion) and a first mating element 120, 220, 320, 420 that is a receptacle (e.g., an aperture) for receiving the first mating element 108, 208, 308, such a configuration is not required. For example, in some embodiments, the second mating element 108, 208, 308 can be a receptacle (e.g., an aperture) and the first mating element 120, 220, 320, 420 can extend from the first main body 106, 206, 306, 406 (e.g., a post or protrusion).

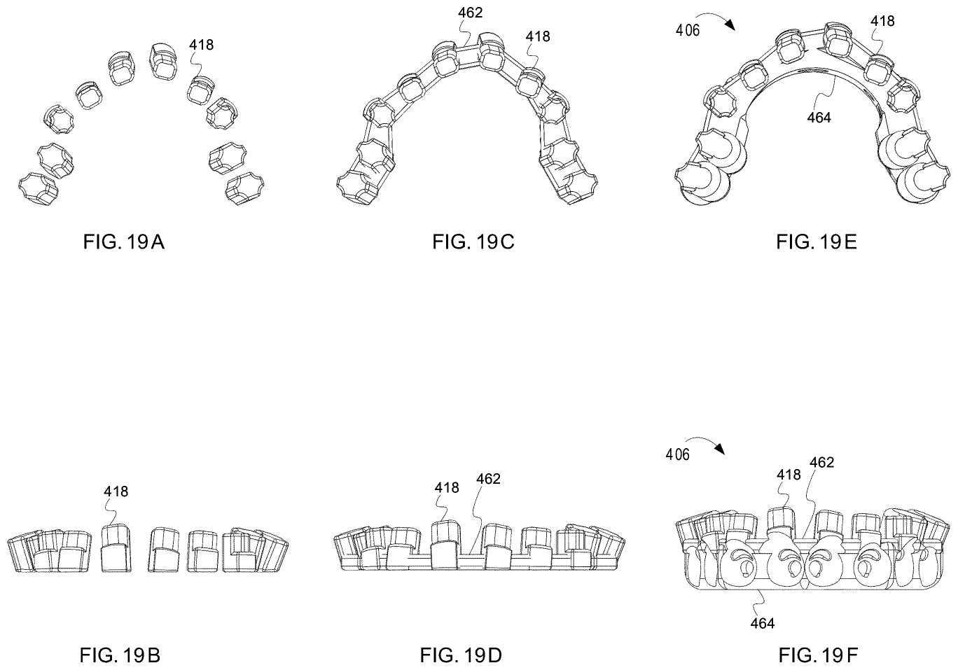

While the discussion of FIGS. 1-18 describes orthodontic systems including a registration assembly and an appliance assembly, the discussion of FIGS. 19-21 provides additional detail regarding the manufacture of such orthodontic systems.

FIGS. 19A-19E depict various stages of design for a registration assembly 406, according to some embodiments. As previously noted, in some embodiments, the registration assembly 406 is additively manufactured as a single (i.e., monolithic) structure. In such embodiments, the registration assembly 406 is defined by a computer data file. The computer data file includes the data necessary to additively manufacture the registration assembly 406.

In one embodiment, and as depicted in FIGS. 19A-19E, the computer data file (i.e., a digital model of the registration assembly 406) is created in stages. FIGS. 19A and 19B depict a top view and a front view, respectively, of a first stage. FIGS. 19C and 19D depict a top view and a front view, respectively, of a second stage. FIGS. 19E and 19F depict a top view and front view, respectively, of a third stage.

During the first stage, as depicted in FIGS. 19A and 19B, initial registration features 416 are formed. At this stage, the registration features 416 are blocks that have not yet been shaped to match the patient's dentition. However, as best seen in FIG. 19A, the locations and orientations of the registration features 416 are based on the patient's dentition. For example, final positions of the patient's teeth can be determined based on a desired final archform, and the locations for origins of each orthodontic appliance can be calculated. The origins for the orthodontic appliances are the locations on the patient's teeth at which the orthodontic appliances will be secured. The registration features are located and oriented based on projections of the patient's teeth from the desired final archform to the initial (i.e., maloccluded) positions.

During the second stage, connectors 462 are added to the computer data file. The connectors are located between the registration features 416. The connectors 462 can take any suitable form, shape, and dimensions. As depicted in FIGS. 19C-19F, the connectors 462 are polygonal shapes that extend between the registration features 416. For example, the connectors 462 can extend between the centers of two adjacent registration features 416. The connectors 462 can be generated manually (i.e., by a human) and/or generated automatically.

During the third stage, a registration assembly base 464 is added to the computer data file. The registration assembly base 464 extends downward from the connectors 462 to provide both structure and room for the first mating elements. As with the connectors 462, the registration assembly base 464 can be generated manually and/or generated automatically. Additionally, the tooth engaging surfaces of the registration features 416 can be formed during the third stage. For example, negatives of the patient's teeth (i.e., all or portion of the lingual surface, facial surface, and occlusal surface of the patient's teeth) are subtracted from the initial registration features 416 to form the final registration features 416. This subtraction can be performed, for example, based on scan of the patient's dentition. It should be noted that this subtraction can be performed during any stage, as well as between stages (i.e., as an additional stage).

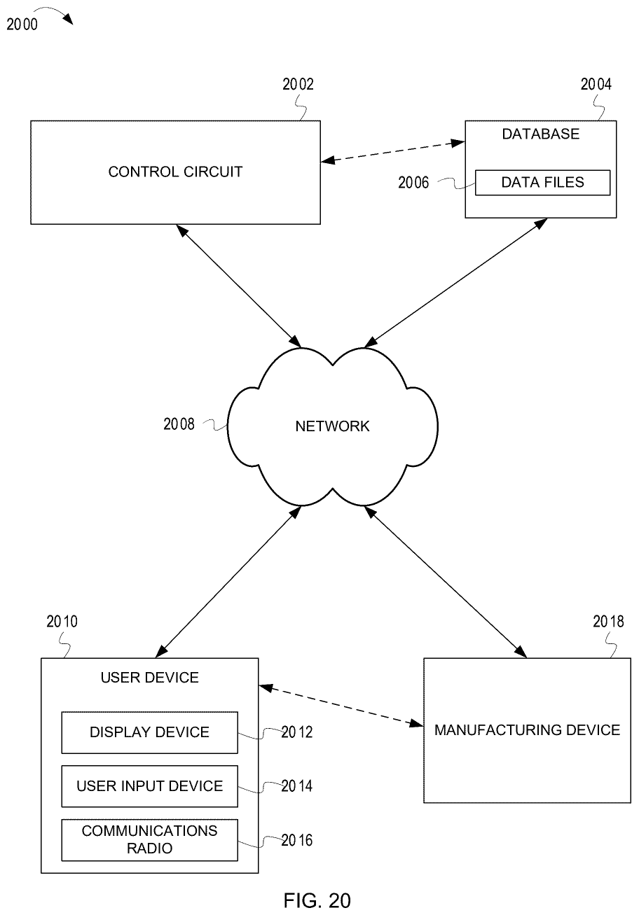

FIG. 20 is a block diagram of a system 2000 for additively manufacturing an orthodontic system, according to some embodiments. The system 2000 includes a control circuit 2002, a database 2004, a user device 2010, and a manufacturing device 2018. One or more of the control circuit 2002, the database 2004, the user device 2010, and the manufacturing device 2018 are communicatively coupled via a network 2008. The network 2008 can include a local area network (LAN) and/or wide area network (WAN), such as the Internet. Accordingly, the network 2008 can include wired and/or wireless links.

The user device 2010 can be any suitable type of computing device (e.g., a desktop or laptop computer, smartphone, tablet, etc.). The user device 2010 includes a display device 2012. The display device 2012 is configured to present a catalogue to a user. The catalogue includes orthodontic appliances that the user can obtain via the system 2000, such as the orthodontic appliances described herein (i.e., orthodontic appliances, orthodontic systems, etc.). For example, the catalogue can include all orthodontic devices that the user can purchase and/or manufacture via the manufacturing device 2018. The user interacts with the catalogue via a user input device 2014. The user can interact with the catalogue by navigating the catalogue, making selections from the catalogue, modifying orthodontic appliances included in the catalogue, etc. Accordingly, the user input device 2014 can be of any suitable type, such as a mouse, keyboard, trackpad, touchscreen, etc. The user device 2010 also includes a communications radio 2016. The communications radio 2016 transmits and receives information for the user device 2010. For example, in the case of a smartphone, the communications radio 2016 can be a cellular radio operating in accordance with the 4G LTE standard. Once a user has made a selection of an orthodontic appliance, the user device 2010, via the communications radio 2016 and the network 2008, transmits an indication of the selection to the control circuit 2002.

The control circuit 2002 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. The control circuit 2002 is configured (for example, by using corresponding programming as will be well understood by those skilled in the art) to carry out one or more of the steps, actions, and/or functions described herein.

By one optional approach the control circuit 2002 operably couples to a memory. The memory may be integral to the control circuit 2002 or can be physically discrete (in whole or in part) from the control circuit 2002 as desired. This memory can also be local with respect to the control circuit 2002 (where, for example, both share a common circuit board, chassis, power supply, and/or housing) or can be partially or wholly remote with respect to the control circuit 2002 (where, for example, the memory is physically located in another facility, metropolitan area, or even country as compared to the control circuit 2002).

This memory can serve, for example, to non-transitorily store the computer instructions that, when executed by the control circuit 2002, cause the control circuit 2002 to behave as described herein. As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).

The control circuit may be remote from the user device 2010 and/or the manufacturing device 2018. For example, the user device 2010 and the manufacturing device 2018 may be located in a clinician's office (e.g., the user's office) whereas the control circuit 2002, and possibly the database 2004, are cloud-based. The control circuit 2002 generally operates to retrieve data files 2006 based on the user's selection of orthodontic appliances. The control circuit 2002 retrieves the data files 2006 from the database 2004. The database 2004 is configured to store the data files 2006. The data files 2006 are associated with orthodontic appliances and/or orthodontic systems. The data files 2006 are CAD files from which the orthodontic appliances and/or orthodontic systems can be manufactured. The database 2004 stores a data file for each of the orthodontic appliances included in the catalogue and/or each of the orthodontic systems included in the catalogue. In one embodiment, the database 2004 stores a data file for all possible permutations of each orthodontic appliance (e.g., every possible modification and/or combination or modifications for each orthodontic appliance). The control circuit 2002 receives the indication of the orthodontic appliance and/or packaged orthodontic appliance and retrieves a data file based on the indication of the orthodontic appliance and/or packaged orthodontic appliance.

It should be noted that the indication of the orthodontic appliance may include more than one orthodontic appliance. For example, the indication of the orthodontic appliance can include multiple orthodontic appliances, such as full set of brackets or other orthodontic appliances for a patient or an orthodontic system including a registration assembly and an appliance assembly. Accordingly, the data file can be a file including instructions and/or specifications for multiple orthodontic appliances as well as structures in addition to the orthodontic appliances. For example, the data file may include multiple data files and/or multiple specifications for a number of brackets.

After retrieving the data file, the control circuit 2002 transmits the data file. In some embodiments, the control circuit 2002 encrypts or otherwise protects the data file before transmission. The control circuit 2002 can encrypt or otherwise protect the data file before transmission to prevent those other than the user from accessing the data file. Additionally, in some embodiments, the control circuit 2002 can encrypt or otherwise protect the data file to control the user's access to the data file. For example, in some embodiments, the system is set up such that users pay on a per manufacture or per print basis. That is, the user does not purchase, and may not later have access to, the data file. Rather, the user purchases access to print or otherwise manufacture an orthodontic appliance based on the data file once (or other specified number of times).

Dependent upon the embodiment, the control circuit 2002 transmits the data file to the user device 2010, the manufacturing device 2018, or a third-party device (e.g., a laboratory capable of manufacturing the orthodontic appliance for the user). To whom, or to what device, the data file is transmitted may also aid in achieving access control. For example, in one embodiment, the control circuit 2002 transmits the data file directly to the manufacturing device 2018. Because the data file is not transmitted to the user device 2010, the data file may not be easily accessible by the user device 2010. Further, if an entity that controls the control circuit 2002 controls the manufacturing device 2018, access may to files received by the manufacturing device 2018 may be further limited. In some embodiments, the control circuit 2002 transmits the data files to the user device 2010. In such embodiments, the user device 2010 transmits, via the communications radio (e.g., over a universal serial bus (USB) connection, wireless connection based on the 802.11 standard, etc.), the data files to the manufacturing device 2018.

The manufacturing device 2018 additively manufacturers the orthodontic appliance(s) and/or orthodontic system based on the data file. The manufacturing device 2018 can be of any suitable type, such as a 3D printer. The manufacturing device 2018 can be local to, or remote from, one or more of the control circuit 2002 and the user device 2010. For example, in one embodiment, the user device 2010 and the manufacturing device 2018 are located in the user's office (i.e., the user device 2010 and the manufacturing device 2018 are local to one another). Alternatively, the manufacturing device 2018 may be located in a laboratory or some other facility that manufactures orthodontic appliances for the user.

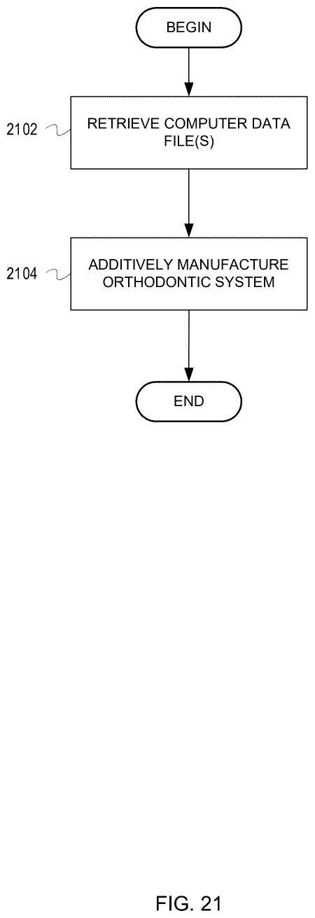

While the discussion of FIG. 20 provides additional detail regarding a system for additively manufacturing orthodontic systems, the discussion of FIG. 21 describes a method for additively manufacturing orthodontic systems.

FIG. 21 is a flow diagram depicting example operations for additively manufacturing an orthodontic system, according to some embodiments. The flow begins at block 2102.

At block 2102, one or more computer data files are retrieved. For example, the one or more data files can be retrieved from a database by a control circuit and/or generated by the control circuit. The one or more computer data files include the data necessary to additively manufacture an orthodontic system. The orthodontic system can be any orthodontic system disclosed herein as well as variations on the different orthodontic systems as well as combinations of one or more features of the different embodiments of an orthodontic system. The orthodontic system generally includes a registration assembly and an appliance assembly. The registration assembly comprises a first main body, at least one registration feature, and a first mating element. The appliance assembly comprises a second main body, a plurality of support structures, a plurality of orthodontic appliances and/or orthodontic appliance receptacles, and a second mating element. The appliance assembly is configured to mate with the registration assembly to indirectly bond orthodontic appliances to teeth in the patient's mouth. The flow continues at block 2104.

At block 2104, the orthodontic system is additively manufactured. For example, a manufacturing device can additively manufacture the orthodontic system. The manufacturing device additively manufactures the orthodontic system based on the one or more computer data files retrieved and/or generated by the control circuit. In one embodiment, the registration assembly is additively manufactured as a single structure and the appliance assembly is additively manufactured as a single structure. It should be noted that, in some embodiments, the appliance assembly and/or the registration assembly can be manufactured as multipiece designs. That is, in some in embodiments, one or both of the appliance assembly and the registration assembly can be manufactured not as single structures. In such embodiments, the appliance assembly and/or registration assembly can be manufactured in multiple pieces to aid in manufacturing and/or based on the patient's dentition (e.g., the patient's malocclusion may be best treated and/or orthodontic appliances may be best located on the patient's teeth with a multipiece appliance assembly and/or registration assembly).

In some embodiments, an orthodontic system comprises a registration assembly, wherein the registration assembly comprises a first main body, at least one registration feature, wherein the at least one registration feature is configured to contact a feature in a patient's mouth to align the orthodontic system in the patient's mouth, and a first mating element, wherein the first mating element includes at least one post extending from the first main body, and an appliance assembly, wherein the appliance assembly comprises a second main body, a plurality of support structures, wherein the plurality of support structures extend from the second main body, a plurality of orthodontic appliances, wherein the plurality of orthodontic appliances are secured to the second main body via the plurality of support structures, and at least one aperture, wherein the at least one aperture is extends into the second main body, and wherein the at least one aperture is configured to mate with the first mating element.

In some embodiments, an orthodontic system comprises a registration assembly, wherein the registration assembly comprises a first main body, at least one registration feature, wherein the at least one registration feature is configured to contact a feature in a patient's mouth to align the orthodontic system in the patient's mouth, and a first mating element, wherein the first mating element includes at least one recess extending into the first main body, and an appliance assembly, wherein the appliance assembly comprises a second main body, a plurality of support structures, wherein the plurality of support structures extend from the second main body, a plurality of orthodontic appliances, wherein the plurality of orthodontic appliances are secured to the second main body via the plurality of support structures, and at least protrusion, wherein the at least one protrusion extends from the second main body, and wherein the at least one protrusion is configured to mate with the first mating element.

In some embodiments, an orthodontic system comprises a registration assembly, wherein the registration assembly comprises a first main body, at least one registration feature, wherein the at least one registration feature is configured to contact a feature in a patient's mouth to align the orthodontic system in the patient's mouth, and a first mating element, wherein the first mating element includes at least one aperture extending into the first main body, and an appliance assembly, wherein the appliance assembly comprises a second main body, a plurality of support structures, wherein the plurality of support structures extend from the second main body, a plurality of orthodontic appliances receptacles, wherein the plurality of orthodontic appliances receptacles are secured to the second main body via the plurality of support structures and configured to receive orthodontic appliances, and at least protrusion, wherein the at least one protrusion extends from the second main body, and wherein the at least one protrusion is configured to mate with the first mating element.

In some embodiments, a method for additively manufacturing an orthodontic system comprises retrieving one or more computer data files, wherein the computer data files include data necessary to additively manufacture the orthodontic system, wherein the orthodontic system comprises a registration assembly comprising a first main body, at least one registration feature, wherein the at least one registration feature is configured to contact a feature in a patient's mouth to align the orthodontic system in the patient's mouth, and a first mating element, wherein the first mating element includes at least one aperture extending into the first main body, and an appliance assembly comprising a second main body, a plurality of support structures, wherein the plurality of support structures extend from the second main body, a plurality of orthodontic appliances receptacles, wherein the plurality of orthodontic appliances receptacles are secured to the second main body via the plurality of support structures and configured to receive orthodontic appliances, and at least protrusion, wherein the at least one protrusion extends from the second main body, and wherein the at least one protrusion is configured to mate with the first mating element, and additively manufacturing, based on the one or more computer data files, the orthodontic system.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1.-20. (canceled)

21. An orthodontic system comprising:
a registration assembly, wherein the registration assembly comprises:
a first main body;
at least one registration feature, wherein the at least one registration feature is configured to contact a feature in a patient's mouth to align the orthodontic system in the patient's mouth; and
a first mating element; and
an appliance assembly, wherein the appliance assembly comprises:
a second main body;
a plurality of support structures, wherein the plurality of support structures extend from the second main body;
a plurality of orthodontic appliances receptacles, wherein the plurality of orthodontic appliances receptacles are secured to the second main body via the plurality of support structures and configured to receive orthodontic appliances; and
a second mating element, wherein the second mating element is configured to mate with the first mating element.

22. The orthodontic system of claim 21, further comprising:
a plurality of orthodontic appliances, wherein each receptacle of the plurality of orthodontic appliance receptacles is configured to releasably retain one orthodontic appliance of the plurality of orthodontic appliances.

23.-27. (canceled)

28. The orthodontic system of claim 21, wherein the first mating element includes two recesses and the second mating element includes two protrusions.

29. The orthodontic system of claim 21, wherein the plurality of support structures includes groups of support structures, wherein each group of support structures is associated with an arm, wherein each arm is located between the second main body and one of the groups of support structures, and wherein each arm includes a plurality of apertures extending therethrough.

30. The orthodontic system of claim 21, wherein the registration assembly is made from a first material, and wherein the appliance assembly is made from a second material that is different than the first material.

31. The orthodontic system of claim 21, wherein the registration assembly is monolithically formed, and wherein the appliance assembly is monolithically formed.

32. The orthodontic system of claim 21, wherein the first mating element includes at least one aperture extending into the first main body, and wherein the second mating element includes at least one protrusion extending from the second main body.

33. The orthodontic system of claim 21, wherein the first mating element includes at least one protrusion extending from the first main body, and wherein the second mating element includes at least one aperture extending into the second main body.

34. The system of claim 21, wherein the appliance assembly is releasably retained by the registration assembly via the first mating element and the second mating element.

35. A method for additively manufacturing an orthodontic system, the method comprising:
retrieving one or more computer data files, wherein the computer data files include data necessary to additively manufacture the orthodontic system, wherein the orthodontic system comprises:
a registration assembly comprising:
a first main body;
at least one registration feature, wherein the at least one registration feature is configured to contact a feature in a patient's mouth to align the orthodontic system in the patient's mouth; and
a first mating element; and
an appliance assembly comprising:
a second main body;
a plurality of support structures, wherein the plurality of support structures extend from the second main body;
a plurality of orthodontic appliances receptacles, wherein the plurality of orthodontic appliances receptacles are secured to the second main body via the plurality of support structures and configured to receive orthodontic appliances; and
a second mating element, wherein the second mating element is configured to mate with the first mating element; and
additively manufacturing, based on the one or more computer data files, the orthodontic system.

36. The method of claim 35, wherein the one or more computer data files includes include at least three computer data files, wherein a first computer data file includes data necessary to additively manufacture the registration assembly, wherein a second computer data file includes data necessary to additively manufacture the appliance assembly, and wherein a third computer data file includes data necessary to additively manufacture at least one orthodontic appliance of the orthodontic appliances.

37. The method of claim 35, further comprising:
a plurality of orthodontic appliances, wherein each receptacle of the plurality of orthodontic appliance receptacles is configured to releasably retain one orthodontic appliance of the plurality of orthodontic appliances.

38.-42. (canceled)

43. The method of claim 35, wherein the first mating element includes two recesses and the second mating element includes two protrusions.

44. The method of claim 35, wherein the plurality of support structures includes groups of support structures, wherein each group of support structures is associated with an arm, wherein each arm is located between the second main body and one of the groups of support structures, and wherein each arm includes a plurality of apertures extending therethrough.

45. The method of claim 35, wherein the registration assembly is made from a first material, and wherein the appliance assembly is made from a second material that is different than the first material.

46. The method of claim 35, wherein the registration assembly is monolithically formed, and wherein the appliance assembly is monolithically formed.

47. The method of claim 35, wherein the first mating element includes at least one aperture extending into the first main body, and wherein the second mating element includes at least one protrusion extending from the second main body.

48. The method of claim 35, wherein the first mating element includes at least one protrusion extending from the first main body, and wherein the second mating element includes at least one aperture extending into the second main body.

49. The system of claim 35, wherein the appliance assembly is releasably retained by the registration assembly via the first mating element and the second mating element.
